(19) United States
(12) Patent Application Publication
(10) Pub. No.: US 2023/0156039 A1
(43) Pub. Date: May 18, 2023

(54) SYSTEM AND METHOD FOR CONTROLLING AUTHORIZATION USING A REQUEST AUTHORIZATION PRIVILEGE MODEL

(71) Applicant: OPEN TEXT CORPORATION, Waterloo (CA)

(72) Inventor: Jody Hupton Palmer, Cambridge (CA)

(21) Appl. No.: 17/987,644

(22) Filed: Nov. 15, 2022

Related U.S. Application Data
(60) Provisional application No. 63/279,567, filed on Nov. 15, 2021.

(51) Int. Cl. H04L 9/40

(52) U.S. Cl. CPC H04L 63/20

(57) ABSTRACT

A server computer comprises a memory configured with references to protected resources hosted by a resource server, authorization policies related to the protected resources, and assignments of users and services to the authorization policies, the authorization policies comprising client authorization policies for authorizing access by services and user authorization policies for authorizing access by users. A request authorization service is configured to receive a request from an application for authorization to access a protected resource hosted by the resource server. Based on a determination that the request is to access the protected resource on behalf of a service, the request authorization uses the client authorization policies, and based on a determination that the request is to access the protected resource on behalf of a user, the request authorization service uses the user authorization policies to determine whether to authorize the request.

### RELATED APPLICATIONS

This application claims the benefit of priority under 35 U.S.C. § 119(e) to U.S. Provisional Application No. 63/279,567, entitled “System and Method for Controlling Authorization Using a Request Authorization Model,” filed Nov. 15, 2021, which is hereby fully incorporated by reference herein.

### TECHNICAL FIELD

This disclosure relates generally to the field of controlling access to resources on a network. More specifically, embodiments relate to access delegation. Even more particularly, embodiments relate to providing secure delegated access to users and services using a request authorization model having separate control realms.

### BACKGROUND

Many online platforms provide access controls that allow users who store information to the platform to control the levels of access that other users will have to the information. Such access control features can allow, for example, the owner of a document stored to an online file storage and sharing platform to control who can access the document and what level of access each user has to the document. Further, users typically expect that various features of the online platform will have access to the information to provide various functionality. A document owner may expect, for example, that they can take advantage of the platform's full-text search capability for the document.

Behind the scenes, some online platforms are a collection of different services with each service providing different types of data processing. For example, a platform's full-text search feature may be provided by a different service than the services responsible for storing documents and implementing user access controls. Typically, once a platform is authorized to access a resource, all the services of the platform can access the resource.

What is desired then are mechanisms to control access by services to online resources.

### SUMMARY

Embodiments described herein provide mechanisms to control access by users and services to protected resources. Some embodiments can be used in conjunction with secure delegated access delegated access mechanisms to enhance the granularity and control by users and to provide controls for services in a multi-service (or other multi-application) environment.

Embodiments provide the ability to check the authorization of a request to access a protected resource by confirming that the caller (as represented by an access token in some embodiments) has the correct privileges over the protected resource. Embodiments can allow clients to define roles and privileges, assign roles to principals in the context of a particular protected resource, and to assign roles to principals in the context of a set of resources grouped into a namespace. Roles can be assigned on a user basis and a client basis.

One embodiment includes a request authorization server computer. Other aspects include related computer-readable media and computer implemented methods. According to one embodiment, the request authorization server computer comprises a memory configured with references to protected resources hosted by a resource server, authorization policies related to the protected resources, and assignments of users and services to the authorization policies. The authorization policies comprise client authorization policies for authorizing access by services executing in a cloud-based platform and user authorization policies for authorizing access by users of the cloud-based platform. The request authorization server computer further comprises a processor coupled to the memory and a non-transitory, computer-readable medium. The non-transitory, computer-readable medium stores thereon a set of computer-executable instructions executable by the processor. The set of computer-executable instructions comprising instructions for: receiving a request from an application for authorization to access a first protected resource hosted by the resource server; based on a determination that the request is to access the first protected resource on behalf of a service, determining whether to authorize the request according to the client authorization policies; based on a determination that the request is to access the first protected resource on behalf of a user, determining whether to authorize the request according to the user authorization policies.

According to some embodiments, the set of computer-executable instructions further comprise instructions for providing different authorization policy control realms for the client authorization policies and the user authorization policies.

The protected resources can be organized according to namespaces and the authorization policies can comprise policies of a namespace scope and policies of a protected resource scope.

According to one aspect of the present disclosure, determining whether to authorize the request may include one or more of: determining if the request is authorized based on any client authorization policies having a namespace scope of the first namespace, determining if the request is authorized based on any client authorization policies having a resource scope of the protected resource; determining if the request is authorized based on any user authorization policies having a namespace scope of the first namespace, determining if the request is authorized based on any user authorization policies having a resource scope of the first protected resource.

In some embodiments, determining that the request is on behalf of a service includes determining that an access token included with the request was granted according to a client credential grant. In some embodiments, a determining that the request is on behalf of a user comprises determining that an access token included with the request was granted according to an authentication code grant or a password grant.

Another embodiment includes a computer-implemented method that comprises receiving an access control model comprising policy definitions for access by services and users to protected resources; storing the access control model in a database; at a requesting service, generating a request to access a protected resource; at an authorization service coupled to the database, receiving the request to access the protected resource; and accessing, by the authorization service, the access control model and determining, based on the access control model, whether to grant the requesting service access to the protected resource or to grant access to the protected resource based on a user associated with the protected resource. If the requesting service is to be granted access, one embodiment of the computer-implemented method comprises modifying the access control model to allow access by the requesting service to the protected resource, including modifying the policy definitions, and accessing, by the requesting service, the protected resource. If it is determined to not grant to the requesting service access, the computer-implemented method may comprise denying the requesting service access. Other aspects include related computer systems and computer-readable media.

Various embodiments may incorporate one or more of the following features: subsequent requests by the requesting service to access the protected resource are based on the modified policy definitions; deploying the access control model; deploying the access control model where deploying the access control model comprises receiving the access control model at the authorization service, the authorization service storing the access control model in the database; the policy definitions of the access control model for at least one of the services is received from a development tool; the policy definitions comprise at least one delegate control model comprising delegate policy definitions, where the determining to grant the requesting service access to the protected resource is further based on the at least one delegate control model; the access control model comprises a namespace; the namespace comprising service role assignments, a service role delegate, user role assignments, a user role delegate, and a protected resource; the protected resource comprising service role assignments, a service role delegate, user role assignments, and a user role delegate; the policy definitions comprising workflow policy definitions; the services include a workflow service and a plurality of task services; receiving, from an administration tool, the workflow policy definitions for the workflow service and for the plurality of task services, where the authorization service determines to grant access between and among the workflow service and the plurality of task services and the protected resources based on the workflow policy definitions.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation for one embodiment of an architecture for request authorization.

FIG. 2 is a flowchart illustrating one embodiment of a method for evaluating authorization requests by the request authorization service.

FIG. 3 is a flowchart of one embodiment of a method of evaluating a request within a scope.

FIG. 4A is a diagrammatic representation of a first example data flow for one embodiment of a cloud platform.

FIG. 4B is a diagrammatic representation of a second example data flow for one embodiment of a cloud platform.

FIG. 4C is a diagrammatic representation of a third example data flow for one embodiment of a cloud platform.

FIG. 5 is a diagrammatic representation of one embodiment of a computer architecture for executing an authorization service.

FIG. 6 is a diagrammatic representation of one embodiment of a distributed computing environment.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

Embodiments of the present disclosure provide a request authorization service that controls access by users and services to protected resources.

A “protected resource” is a resource to which access is restricted to authorized entities (e.g., users, applications, or other specified entities). For example, access to a protected resource may be protected based on processing by a request authorization service that authorizes requests based on entity or processing by an authorization server that issues access tokens used to access the resource.

A “resource owner,” with respect to a protected resource, is an entity capable of granting access to the protected resource. When the resource owner is a person, the resource owner may be referred to as an end-user. A “resource server” is a server hosting protected resources.

A “client” is an application that makes protected resource requests, typically on behalf of a resource owner and with the resource owner's authorization. A protected resource request may be made on behalf of a user (e.g., an end-user) or outside of the context of a user. A client may make a protected resource request outside of the context of a user for several reasons. For example, a client may make a protected resource request outside of the context of a user to access resources owned by the client. A client may make a resource request outside of the context of a user for other types of protected resources based on authorizations configured at an authorization server or a request authorization service.

When a client makes a protected resource request on behalf of a user, the client uses credentials of the user or credentials granted dependent on the user. In some embodiments, the client uses credentials that represent a user-dependent authorization by the resource owner to access the protected resource. In even more particular embodiments, the client uses an access token issued dependent on user authentication (e.g., using the user's username and password or other user credentials).

According to some embodiments, when a client makes a protected resource request outside of the context of a user, the client uses credentials of the client itself or credentials granted dependent on the client. By way of example, but not limitation, the client credentials may include a client id and a client secret assigned to the client. In some embodiments, the client uses credentials that represent a client-dependent authorization by the resource owner to access the protected resource. In even more particular embodiments, the client uses an access token issued based on client authentication using client credentials or other form of client authentication.

An “authorization server” is a server that issues access tokens to the client after successfully authenticating the resource owner and obtaining authorization. Access tokens are credentials used to access protected resources. An access token represents an authorization issued to a client. In some embodiments, an access token is a string representing an authorization issued to a client. Access tokens may represent specific scopes and durations of access, granted, for example, by the resource owner, and enforced by the resource server, the authorization server, or a request authorization service.

In some embodiments, the protected resources are resources accessible through a

Representational State Transfer (ReST) interface. ReST (or ReSTful) interfaces abstract information accessible through the interface as resources. The resources can be files, streaming media, data provided by services, data provided by queries, or any of a broad variety of other types of data. A request to access a ReST resource typically includes a resource identifier (e.g., a URL that specifies a path or query string to the resource or other resource identifier), a method to perform (e.g., a hypertext transfer protocol (HTTP) method), a header, and request data (also referred to as the request body) as needed. Headers provide metadata about the message body, credentials (user credentials, client credentials, access tokens or other credentials), cookies, format of the request or response, information about request status, and other information. Thus, in some embodiments, a request to access a protected ReST resource may include an access token.

According to embodiments of the present disclosure, a request authorization service provides the ability to check the authorization of a request by confirming that the caller—as represented by an access token, for example—has the correct privilege over the protected resource. The request authorization service allows clients to define roles and privileges, assign roles to principals in the context of a particular protected resource, and to assign roles to principals in the context of a set of resources grouped into a namespace.

An entity can establish user access policies for users and client access policies for clients (e.g., services) to control the level of access that users and clients have to protected resources. When the request authorization service receives a request to access a protected resource, the request authorization service determines whether the request is on behalf of a service or on behalf of a user. If the request is on behalf of a service, the request authorization service uses the client authorization policies to determine whether to authorize the request. If the request is on behalf of a user, the request authorization service uses the user authorization policies to determine whether to authorize the request. In some embodiments, the determination of whether the request is on behalf of a user or on behalf of a service is based on whether the access request is a client credential grant request.

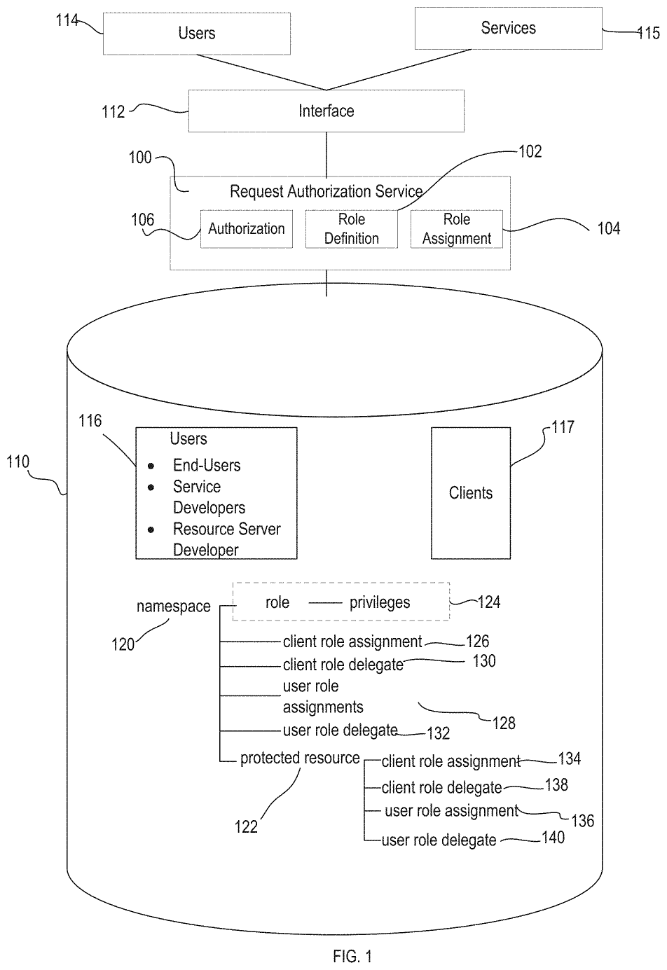

FIG. 1 is a diagrammatic representation for one embodiment of an architecture for request authorization. In the embodiment of FIG. 1, a server executes a request authorization service 100, which is used by other programs to obtain authorization to access protected resources (for example, protected endpoints) at a resource server. Request authorization service 100 may be executed at various locations in an architecture, including, but not limited to as a service of a resource server—for example, a ReST resource server. In the context of FIG. 1, a “protected resource” is any resource to which access is protected based on processing by request authorization service 100. In some embodiments, each protected resource is a ReST resource.

Request authorization service 100 is executable to provide several features including a role definition component 102, a role assignment component 104, and a request authorization component 106. Role definition component 102 allows users with appropriate privileges to define roles for namespaces and protected resources. Role assignment component 104 allows users with appropriate privileges to assign roles to users and clients for namespaces and protected resources. Request authorization component 106 processes requests to access protected resources to allow or deny the requests. In some embodiments, request authorization components 106 communicates with an authorization server or other services to validate access tokens or request additional information used to allow or deny an access request.

Request authorization service 100 is backed by a datastore 110 that stores roles and role assignments for namespaces and protected resources of the resource server. In some embodiments, datastore 110 stores user information 116 (such as user ids and other information) about users and client information 117 (such as client ids or other information) used by role definition component 102, role assignment component 104, or request authorization component 106.

The architecture of FIG. 1 includes an interface 112, such as ReST interface (e.g., a ReST interface of a ReST resource server), via which request authorization service 100 receives access requests from clients (e.g., services or other applications) requesting authorization on behalf of users and services to access protected resources. In some embodiments, request authorization service 100 is a ReSTful service of a resource server that uses an industry-standard open authorization (OAuth) protocol as defined by the Internet Engineering Task Force, such as the OAuth 2.0 protocol. As will be appreciated, OAuth is an open standard for access delegation. The Internet Engineering Task Force (IETF), Request for Comment 6749, “The OAuth 2.0 Authorization Framework,” October 2012, is hereby fully incorporated herein by reference for all purposes.

In some embodiments, request authorization service 100 provides an additional authorization layer after an access token has been issued to a client (e.g., by an authorization server) and the caller is authorized to call a service. More particularly, the request authorization service 100 can provide finer granularity control over the level of access a principal has to protected resources.

In the embodiment of FIG. 1, users 114 and services 115 call the resource server to access protected resources. A user is the caller for protected resource requests made by a client on behalf of the user (in the context of the user using credentials of the user or granted dependent on the user). A service is the caller with respect to protected resource requests made by a client, which may be the service itself, on behalf of the service not in the context of a user.

According to one embodiment, request authorization service 100 implements an authorization control privilege model that has separate authorization control realms for users and services, supports definable roles and privileges (e.g., in a namespace), and holds references to protected resources. Some embodiments support HTTP methods as privileges and the use of URL path segments as resource identifiers. In some embodiments, the authorization control privilege model is compatible with an access control list (ACL) model. In some embodiments, the authorization control privilege model supports one or more of the following exemplary features: ready for use with a gateway policy enforcement point (PEP), supports authorization contracts between resources, enables low latency authorization decisions, is scalable with the number of protected resources, and is scalable with the number of requests per second.

The request authorization service 100 provides separate controls for different authorization realms. According to one embodiment, these realms include a user access realm, a mutable service access realm, and a required service access realm. With respect to the user access realm, a user who created a resource has complete control over the user access realm for the resource. The user who created the resource may give control over this realm to other services or users as they see fit. For example, not only may a user who created a document share the document, they may give others the right to share it too.

Turning to the mutable service access realm, according to one embodiment, the developers of a service (or other client) that calls the resource server to create resources has complete control over this realm for resources created by the developer's service. For example, the developer of a service has control over and can establish policies for a namespace created by or for the developer's service. By virtue of having created a namespace or resource, the service may set permissions, giving users access to the namespace or resource. The developer may want to ensure that their service always has access to the resources created by the service. Thus, in some embodiments, users who are not the developer of the service that created the resource cannot remove mutable service access from the resource.

According to one embodiment, the resource server developer has complete control over the required service access realm. The developer of the resource server can determine which services must be allowed to call their service (i.e., call the resource server) and which users must be allowed to call their service.

According to one embodiment of an authorization control privilege model, protected resources are grouped into namespaces (e.g., namespace 120 is illustrated, though there may be any number of namespaces). According to one embodiment, new namespaces are created on the deployment of a new service 115 or upgrades to a service 115 that requires additional namespaces.

A namespace 120 may include any number of protected resources. Thus, protected resources can be organized according to namespace (for example, protected resource 122 is illustrated as part of namespace 120. As will be appreciated, the datastore 110 of request authorization service 100, in some embodiments, contains references to the protected resources (for example URL path segments) and not the resources themselves.

A namespace owner has privileges to define roles and assign privileges to the roles for the namespace and resources in the namespace. Roles are collections of privileges. In some embodiments, HTTP methods are used as privileges. For example, a role can include a listing of HTTP methods that the role is authorized to perform. Principals (e.g., users and clients) are assigned to the defined roles in a context, where the context is a namespace or a protected resource. Namespaces and roles may also be assigned delegates that are used by request authorization service 100 for request authorization. An authorization policy for a namespace comprises the collection of roles and assignment of principals to roles for a namespace (whether defined specifically for the namespace, defined through a delegate, or otherwise defined) may be considered an authorization policy for the namespace. An authorization policy for a protected resource comprises the roles and assignments of principles to roles for the protected resource (whether defined specifically for the protected resource, defined through a delegate, or otherwise defined).

In the embodiment of FIG. 1, for example, role 124 is a defined collection of privileges (one or more privileges). For example, role 124 may be a named collection of HTTP methods. Client role assignment 126 is the assignment of a role to one or more clients for the namespace 120. A client role for a namespace thus a role (a defined collection of privileges) assigned to the one or more clients for the namespace. While only one client role assignment is illustrated for namespace 120 there can be multiple client roles assigned for a namespace. User role assignment 128 is the assignment of a role to one or more users for the namespace 120. A user role for a namespace thus represents a role (a defined collection of privileges) assigned to one or more users for the namespace. While only one user role assignment is illustrated for namespace 120, there are multiple user roles assigned for a namespace.

A namespace may have delegates (e.g., client role delegate 130, user role delegate 132) that reference one or more other namespaces (delegate namespaces). The request authorization service 100 uses the client roles or user roles from the delegate namespaces when evaluating requests for resources in namespace 120.

Client roles, user roles, client role delegates, and user role delegates may also be assigned to protected resources in a namespace. Continuing with the example of FIG. 1, client role assignment 134 assigns a role (a defined collection of privileges) to one or more clients (that is, applications) role for the protected resource 122. User role assignment 136 assigns a role to one or more users assigned for the protected resource 122. While only one client role assignment and user role assignment are illustrated for protected resource 122, there may be multiple client roles and user roles assigned for a protected resource. A protected resource may have delegates (e.g., client role delegate 138, user role delegate 140). Client role delegate 138 and user role delegate 140 may reference one or more other protected resources or namespaces such that the request authorization service 100 uses the client roles or user roles from the other protected resource or namespace when evaluating requests to access the protected resource 122.

The role/privilege model is isomorphic to the ACL model in the special case where there is a role with a single privilege for each privilege in the system. Assigning the role to a resource/principal pair then can have the same effect as assigning a privilege to a resource/principal pair in an ACL model.

As mentioned, the request authorization service 100 may hold references to the protected resources. This eases adoption as teams do not have to alter their databases. The request authorization service 100 holding references to the protected resources also makes it possible for the policy enforcement point to be moved into a gateway. According to one embodiment, the request authorization service 100 supports the HTTP methods as privileges and the use of URL path segments as resource identifiers so that it is ready for use by a gateway acting as the policy enforcement point.

According to some embodiments, request authorization service 100 supports contracts between namespaces and resources. For example, by assigning a delegate to resource A that delegates authorization to resource B, any changes in resource B's authorization policy are picked up by resource A.

In some embodiments, the request authorization service 100 supports low latency evaluation of authorization decisions.

The request authorization service 100 can support scalability for the number of protected resources by, for example, distributing the data used by the request authorization service 100.

The request authorization service 100, in some embodiments, supports scalability with the number of requests per second through the use of replicated data.

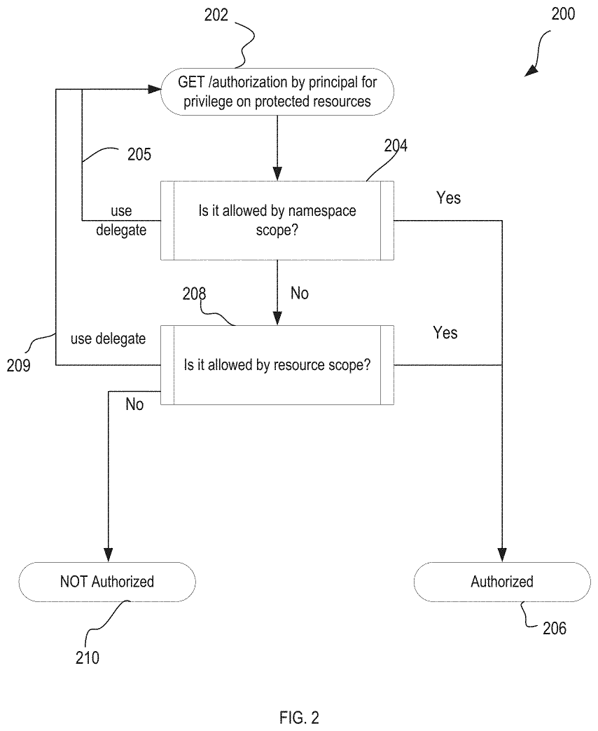

FIG. 2 is a flowchart illustrating one embodiment of a method 200 for evaluating authorization requests by the request authorization service 100. In one embodiment, the steps of FIG. 2 may be embodied as computer-executable instructions stored on a non-transitory, computer-readable medium.

In the example of FIG. 2, protected resources can be grouped into namespaces and authorization policies assigned at the namespace level. Additionally, authorization policies can be assigned to individual resources. Furthermore, a namespace or a resource may have an associated delegate such that authorization policies that apply to the delegate apply to the associated namespace or resource. Other paradigms for assigning authorization policies may be used.

Request authorization service 100 receives an access request requesting access to a protected resource for a principal (step 202). The protected resource can be any resource for which there is an authorization policy according to which access to the resource by users or services is controlled by request authorization service 100. In one embodiment, the principal is identified by an access token and the resource by a resource identifier, such as a URL, object ID, or another identifier.

Request authorization service 100 determines if the access request is authorized based on the namespace scope (step 204). In particular, request authorization service 100 determines if the access request is allowed based on the authorization policies assigned to the namespace to which the requested resource belongs. If the namespace is assigned a delegate, request authorization service 100 evaluates the access request using the authorization policies assigned to the delegate namespace (indicated at 205). If the access request is allowed based on the authorization policies assigned to the namespace of the resource (or delegate namespace), request authorization service 100 authorizes the request (step 206). For example, request authorization service 100, in one embodiment, returns a request authorization to the requestor.

If the authorization request is not allowed based on the namespace scope, request authorization service 100 determines if the access request is authorized based on the resource scope (step 208). In particular, request authorization service 100 determines if the access request is allowed based on the authorization policies assigned to the requested resource—that is, the authorization policies assigned to the resource to which access is requested. If the resource is assigned a delegate, request authorization service 100 evaluates the access request using the authorization policies assigned to the delegate resource (indicated at 209). If the access request is allowed based on the authorization policies assigned to the requested resource (or delegate resource), request authorization service 100 authorizes the request (step 206). For example, request authorization service 100 returns a request authorization to the requestor. If the access request is not allowed based on the resource scope, request authorization service 100 denies the request (step 210). For example, request authorization service 100 sends a request denial to the requestor.

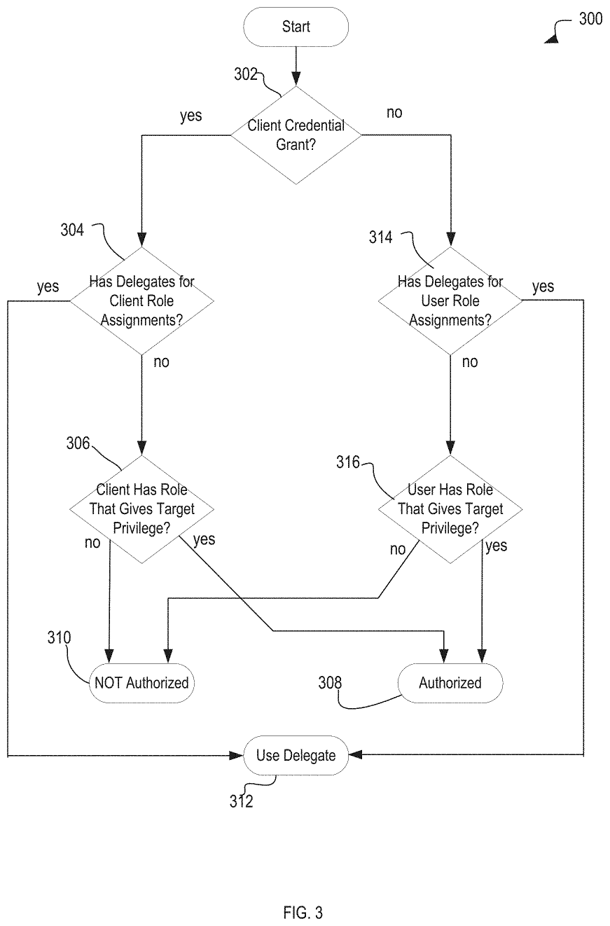

FIG. 2 is merely an illustrative example, and the disclosed subject matter is not limited to the ordering or number of steps illustrated. Embodiments may implement additional steps or alternative steps, omit steps, or repeat steps. In some embodiments, for example, the determination of whether a request is authorized can be performed using a single database query.FIG. 3 is a flowchart of one embodiment of a method 300 of evaluating a request within a scope (e.g., namespace scope, resource scope). For example, method 300 may be performed at step 204 for a namespace scope and at step 208 for a resource scope. Steps of FIG. 3 will be discussed in terms of “namespace/resource” as method 300 applies, at step 204, to the namespace scope and, at step 208, to the resource scope. In one embodiment, the steps of FIG. 3 may be embodied as computer-executable instructions stored on a non-transitory, computer-readable medium.

Request authorization service 100 determines if the access request is a request for access by a user or a request for access by a service (step 302). More particularly, in one embodiment, request authorization service 100 evaluates the access token to determine the grant type of the token. For example, the request authorization service 100 evaluates the access token to determine if the access token was issued based on a client credential grant type or based on a grant type that used user credentials (e.g., an authorization code grant type or password grant type) for an OAuth 2.0 token. In some embodiments, this information is encoded as part of the token itself or accompanies the token in the request. For example, the grant type or information from which the grant type can be determined is encoded or included as part of the token. In some embodiments, the token includes or is accompanied by a client_id. In some embodiments, a token granted based on user credentials includes or accompanied by a user_id and, in some implementations, a client_id. According to one embodiment, if the access token in the access request was issued based on a client credential grant type, this indicates that the principal is a service and, if the access token was issued based on an authorization code grant request or password grant type, which includes user context, this indicates that the access request is a request for access by a user.

If the access request is a request to allow a service to access a protected resource, control passes to step 304. Request authorization service 100 determines if the namespace/resource delegates service authorization to another namespace/resource. For example, request authorization service determines if the namespace/resource has delegates for client role assignments. If the namespace/resource does not delegate service authorization to another namespace/resource, control passes to step 306.

The request authorization service determines if the client has a role that gives the client permission for the requested access (step 306). At this step, the service authorization policies for the namespace scope (step 204) or the protected resource (step 208) are used. If the client has a role that gives the client permission for the requested access, request authorization service 100 authorizes the request (step 308). If the client does not have a role that gives the client permission for the requested access, the request is determined not to be allowed by the namespace/resource scope (step 310).

Returning briefly to step 304, if the namespace/resource delegates service authorization to another namespace/resource, method 300 may be performed using the delegate namespace/resource as the scope (step 312)—that is, request authorization service 100 may perform step 306 using the service authorization policies assigned to the delegate namespace/resource to evaluate the request.

If the access request is a request to allow a user to access a protected resource (e.g., the access request is a request for an authorization code grant), control passes to step 314. request authorization service 100 determines if the namespace/resource delegates user authorization to another namespace/resource. For example, request authorization service 100 determines if the namespace/resource has delegates for user role assignments. If the namespace/resource does not delegate user authorization to another namespace/resource, control passes to step 316.

The request authorization service 100 determines if the user has a role that gives the user permission for the requested access (step 316). At this step, the user authorization policies for the namespace/resource are used. If the user has a role that gives the user permission for the requested access, request authorization service 100 authorizes the request (step 308). If the user does not have a role that gives the user permission for the requested access, the request is determined not to be allowed by the namespace/resource scope (step 310). Returning briefly to step 314, if the namespace/resource delegates user authorization to another namespace/resource, method 300 may be performed using the delegate namespace/resource as the scope (step 312)—that is, request authorization service 100 may perform step 316 using the user authorization policies assigned to the delegate namespace/resource to evaluate the request.

FIG. 3 is merely an illustrative example, and the disclosed subject matter is not limited to the ordering or number of steps illustrated. Embodiments may implement additional steps or alternative steps, omit steps, or repeat steps. In some embodiments, for example, the determination of whether a request is authorized can be performed using a single database query.

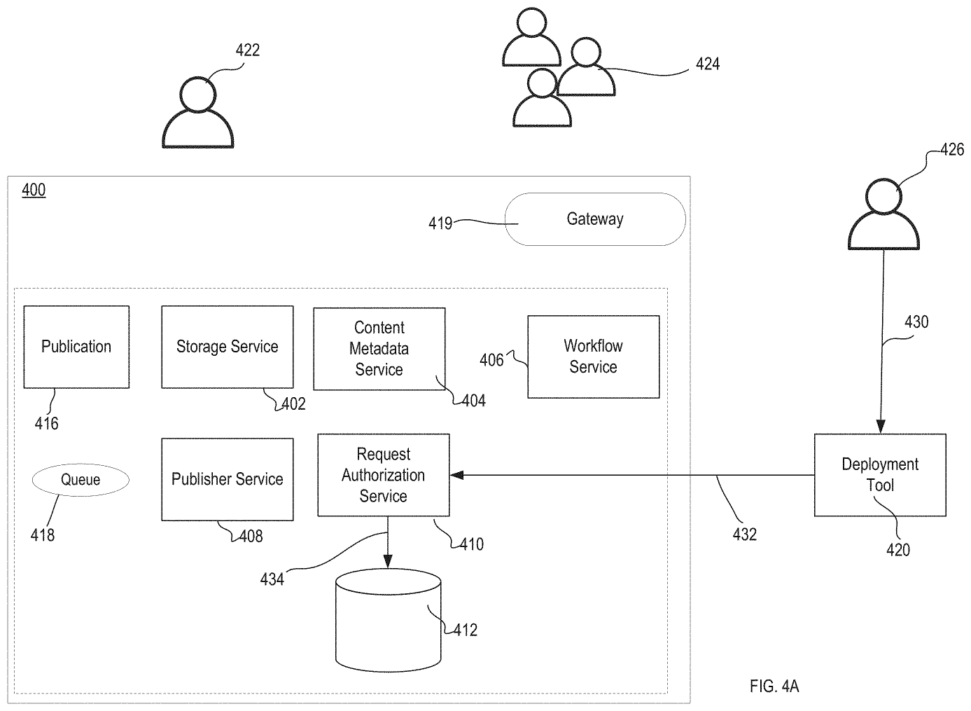

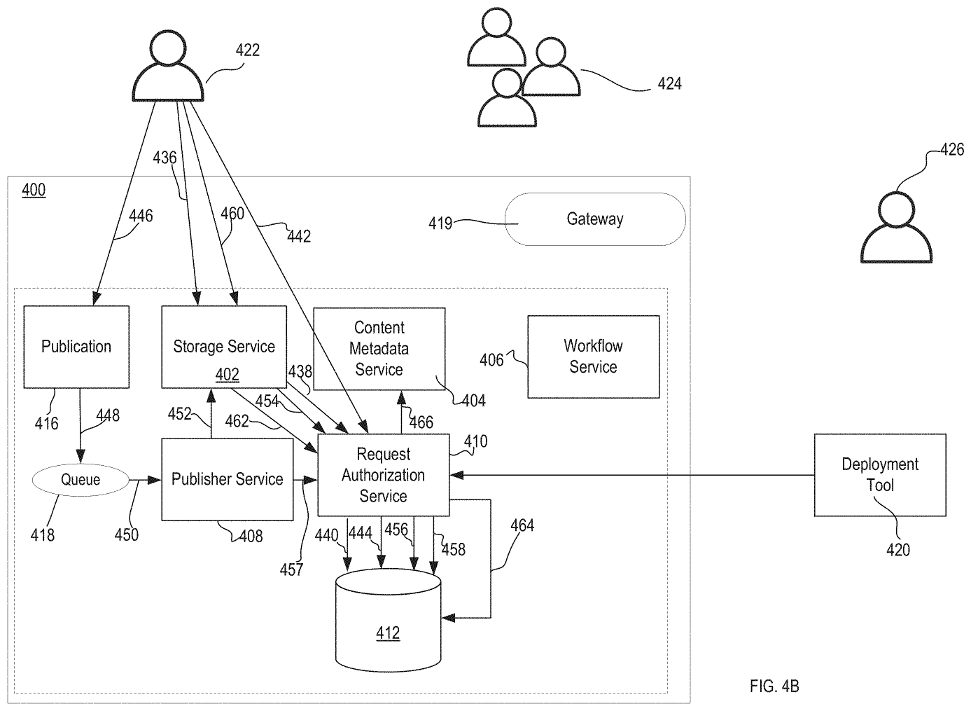

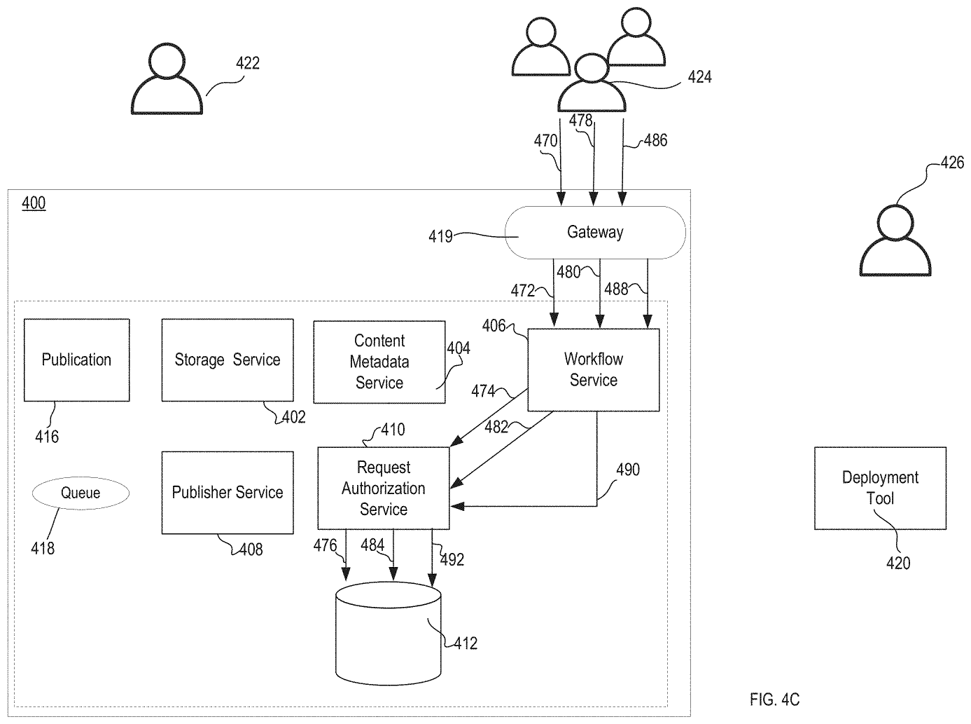

FIG. 4A is a diagrammatic representation of one embodiment of a cloud platform 400 comprising a plurality of services including a file storage service 402, a content metadata service 404, a workflow service 406, a publisher service 408, a request authorization service 410, which may be one embodiment of the request authorization service 100, a request authorization service database 412, which may be one embodiment of datastore 110, and a publication service 416. The cloud platform 400 further includes a queue 418 discussed below and a gateway 419. A deployment tool 420 may be used to deploy services to the cloud platform. Further, a user 422, users 424, and a DevOps user 426 are illustrated. As will be appreciated, the users may perform various operations with respect to cloud platform 400 via user applications (e.g., user-agents such as web browsers or other applications). Implicit to FIG. 4A, but not illustrated, is an authorization server that issues access tokens to clients (e.g., according to the OAuth 2.0 protocol).

FIG. 4A further illustrates an example data flow in which namespaces are created as needed by DevOps. The DevOps user 426 uses deployment tool 420 (step 430) to deploy a new service to the platform. At step 432, the deployment tool 420 posts a namespace. The request authorization service 410 determines if the deployment tool 420 is authorized to post the namespace. For example, the deployment tool 420 authenticates (e.g., using OAuth2 or another protocol) using a client id to receive an access token from an authorization server (not illustrated). Thus, the access token in a request to post the namespace will be an access token based on a client credential grant. The request authorization service 410 determines that deployment tool 420 has CreateNameSpace Scope. At step 434, the request authorization service 410 creates the tables for the namespace in the request authorization service database 412. According to one embodiment, the developer of the service that uses the namespace has permissions to define roles and assign client roles, user roles and delegates to the new namespace.

FIG. 4B is a diagrammatic representation of one embodiment of a data flow in which the user 422 uploads a file, alters the permissions on the file so that the file has a permission contract with a content metadata service object maintained by the content metadata service 404, submits the file for publication, and views the artifacts created by publication. While not shown, the user's client can seek authorization from an authorization server to use the file storage service on behalf of the user. For the sake of example, it will be assumed that an access token is issued based on an OAuth 2.0 authorization code grant type.

At step 436, user 422 uploads a file storage service 402. In this case, the client includes the access token granted using the authorization code grant type in the request to upload the file. The file storage service 402, and the client being used by the user 422 may interact to authorize the user to use the file storage service 402 to upload the file.

At step 438, the file storage service 402 defines access for the file. In other words, the file storage service 402 defines an authorization policy for the file. According to one embodiment, the file storage service 402 requests authorization to define access for the file using an OAuth2 access token issued according to a client credential grant, and the request authorization service 410 bases authorization on the client roles assigned directly or via delegation to the namespace of which the file is part, or the client roles assigned directly or via delegation to the file itself. If the file storage service 402 is authorized to define access for the file, the request authorization service 410 saves the authorization policy to the database 412 (step 440).

At step 442, user 422 modifies the permissions on the file, and in particular sets a contract with a content metadata service object. For example, the user assigns a delegate to the file. According to one embodiment, the request to modify the permission on the file includes an OAuth access token granted based on an authentication code grant and, as such, request authorization service determines that the request is a request on behalf of a user. Request authorization service 410 bases authorization on the user roles assigned (directly or via delegation) to the namespace of which the file is part, or user roles assigned (directly or via delegation) to the file itself. At step 444, the request authorization service 410 stores the modified permissions for the protected resource—that is, the modified authorization policy for the file uploaded at step 436.

At step 446, the user interacts with publication service 416 to create a publication from the file. Again, the user's client uses an access token based on an authentication grant. The publication service 416, and the client being used by the user 422 to interact with the publication service 416 to authorize the user to call the publication service 416 to publish the file.

At step 448, the publication service 416 writes a publication request to queue 418. At step 450, the publisher service 408 picks up the publication request. At step 452, the publisher service 408 writes a new artifact to the file storage service 402. According to one embodiment, the publisher service 408 requests authorization to create the artifact using an OAuth2 access token issued based on a client credential grant type.

At step 454, the file storage service 402 defines access for the artifact. In other words, the file storage service 402 defines an authorization policy for the artifact. According to one embodiment, the file storage service 402 requests authorization to define access for the artifact using an access token issued according to an OAuth2 client credential grant type. As such, request authorization service 410 bases authorization on the client roles assigned (directly or via delegation) to the namespace of which the file is part, or the client roles assigned (directly or via delegation) to the file itself. If the file storage service 402 is authorized to define access for the file, the request authorization service 410 saves the authorization policy to the database 412 (step 456).

At step 457, the publisher service 408 modifies the access definition for the artifact—that is, modifies the authorization policies for the artifact. According to one embodiment, the publisher service 408 requests authorization to modify access for the artifact using an access token according to an OAuth2 client credential grant type, and the request authorization service 410 bases authorization on the client roles assigned (directly or via delegation) to the namespace of which the file is part, or the client roles assigned (directly or via delegation) to the file itself. If the publisher service 408 is authorized to modify access for the file, the request authorization service 410 saves the modified authorization policy to the database 412 (step 458).

At step 460, the user accesses the published artifact. The client being used by the user 422 uses an OAuth 2.0 access token issued based on an authentication code grant to interact with the file storage service 402.

At step 462, the file storage service 402 requests that the request authorization service 410 authorize the user. According to one embodiment, this may be done using an access token granted according to an OAuth 2.0 client credential grant request. As such, the request authorization service 410 bases authorization on the client roles assigned (directly or via delegation) to the namespace of which the file is part, or the client roles assigned (directly or via delegation) to the file itself.

At step 464, the request authorization service 410 checks the database 412 and determines that the artifact has authorization delegated to a content metadata service object. At step 466, the request authorization service 410 checks the content metadata services object for authorization policies for authorizing the user.

FIG. 4C illustrates an example in which a user models a workflow, including modeling roles. Another user instantiates the workflow and assigns people to roles. A final user takes a workflow step.

At step 470, a user models a workflow (e.g., via DevX). According to one embodiment, the client being used by the user to interact with the gateway 419 uses an access token granted according to an authorization code grant type in requests to gateway 419 on the user's behalf to model the workflow.

At step 472, gateway 419 interacts with the workflow service 406 to model the workflow. Again, the access token granted based on the authentication code grant type is used by gateway 419 in requests to the workflow service 406 on behalf of the user to model the workflow.

At step 474, the workflow service 406 interacts with the request authorization service 410 to create roles for the workflow model, which can include adding a reference to the workflow to database 412 in the appropriate namespace. According to one embodiment, the workflow service 406 uses an access token granted to workflow service 406 based on a client credential grant to request to create roles for the workflow model. The request authorization service 410 bases authorization to create the roles on the client roles assigned (directly or via delegation)to the namespace of which the workflow model is part, or client roles assigned (directly or via delegation) to the workflow model itself. The request authorization service 410 saves the roles to the database 412 (step 476).

At step 478, a workflow user calls the gateway 419 to instantiate the workflow model and assign users tasks. According to one embodiment, the client being used by the user to interact with the gateway 419 uses an access token issued according to an authorization code grant to call gateway 419 to instantiate the workflow, and assign users tasks.

At step 480, gateway 419 interacts with the workflow service 406 to instantiate the workflow and assign the users tasks. Gateway 419 uses the access token issued according to the authentication code grant type when interacting with workflow service 406 to instantiate the workflow and assign tasks to users.

At step 482, the workflow service 406 interacts with the request authorization service 410 to assign users to roles for the model. According to one embodiment, the workflow service 406 requests authorization to create the roles using an access token granted to workflow service 406 according to a client credential grant type. The request authorization service 410 bases authorization to create the roles on the client roles assigned or delegated to the namespace of which the workflow model is part, or client roles assigned or delegated to the workflow model itself. The request authorization service 410 saves the roles to the database 412 (step 484).

At step 486, a workflow user performs a task assigned to the user for the workflow. According to one embodiment, the client being used by the user uses an access token issued according to an authentication grant type in requests to the gateway on the user's behalf when performing the task.

At step 488, gateway 419 interacts with the workflow service 406 to perform the task. According to one embodiment, gateway 419 uses the access token granted based on the authentication code grant type in requests on the user's behalf to workflow service 406 to perform the task.

At step 490, the workflow service 406 checks user authorization. According to one embodiment, the workflow service 406 uses an access token issued to workflow service 406 based on a client credential grant type in requests to check user authorization. At step 492, the request authorization service 410 looks up authorization for the workflow instance. The request authorization service 410 bases authorization on the client roles assigned or delegated to the namespace of which the workflow model is part, or client roles assigned or delegated to the workflow model itself.

Multi-service platforms and architectures require access to protected resources as well as cross-execution between and among services in a secure manner. The inventive subject matter comprises computer and machine-driven architectures, methodologies, and techniques for authorizing services access to protected resources and other services. An authorization service may be designed, deployed, and managed to mediate secure access (via an access control model) to the protected resources and other services which execute and communicate on a system, such as, but not limited to, a software-as-a-service platform and/or distributed computing environment.

The inventive subject matter mitigates problems in existing systems which fail to properly protect resources and services in a secure, configurable, and flexible fashion. A provided access control model configures a variety of policy definitions for access and control over protected resources and services. An authorization service leverages the access control model to mediate interactions with protected resources and between and among services in a secure manner. Services request authorization to other services via the authorization service and, if granted, may call other services, access protected resources, and modify the access control model in a highly dynamic environment. If requests are not granted, then the services are not permitted and/or blocked from calling services and unable to access protected resources.

In this way, advantageously, a service is granted permission in a controlled and predictable manner to access resources and other services on a platform. Development and administrative tools may configure initial security parameters for protected resources and services including those specified in the access control model. The access control model may be described as a security framework with the flexibility to be modified in response to dynamic needs of application services. A high-level of granularity and control is enabled with policy definitions that apply to specific services or sets of services and protected resources.

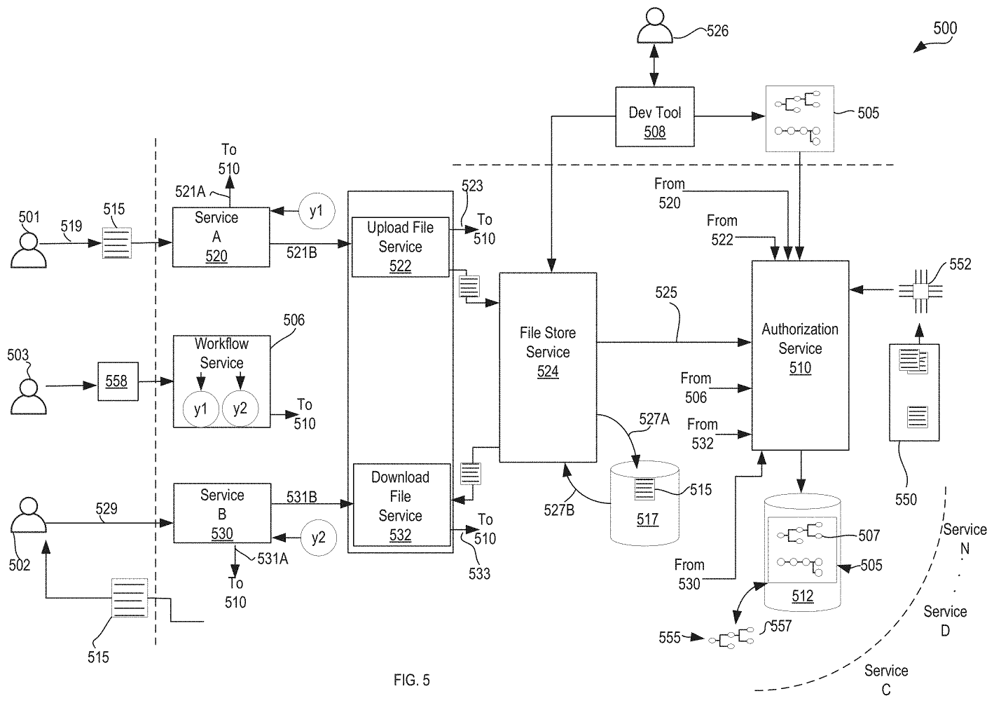

Referring now to FIG. 5, a set of instructions 550 is loaded on to a processor 552 of a computer architecture 500 for executing an Authorization Service 510 to receive an access control model 505 for authorizing services access to protected resources (e.g., file 515). Non-limiting examples of services include Service A 520, Service B 530, Service C, Service D through Service N, Upload File Service 522, Download File Service 532, and Store File Service 524 and a non-limiting example of protected services includes file 515. The access control model 505 comprises policy definitions 507 for access by services and users to protected resources (such as file 515) and is stored in a database 512. A requesting service (for example, Service 520) generates a request to access a protected resource and Authorization Service 510 receives the request to access the protected resource (e.g., file 515). The Authorization Service 510 references the access control model 505 and determines, based on the access control model 505, whether to grant the requesting service 520 access to the protected resource (e.g., file 515). Alternatively, access to the protected resource (e.g., file 515) may be granted based on user or group permissions associated with the protected resource (e.g., file 515).

In a nonlimiting embodiment, a development team is responsible for one or more services and a workflow team leverages the one or more services as part of a workflow to accomplish a task. Here, the development team uses a development tool to design an access framework for the one or more services and protected resources and then deploys the access framework (as part of the policy definitions of the access control model). The access framework may be modified and/or further refined by a workflow team (in a non-limiting example) to enable workflows to execute the one or more services which, in combination with a greater set of services, perform tasks. Here, the workflow team uses a workflow tool to fine-tune the access framework to meet the needs and desires of a workflow, including sharing services and protected resources between and among a set of users, groups, tasks, roles, etc. Alternatively, or in addition to, an administration tool may be used by an administrator to configure, update and/or reprovision the access control model and policy definitions. Advantageously, such flexibility allows the overall platform to expand its services, adapt to security needs and desires, and respond to needs and desires of the organization.

In some embodiments, an authorization service receives an access control model and stores the access control model in a database. As explained in the example above, policy definitions of the access control model for services may be received from a development tool, and access parameters of the services may be modified by a workflow tool to enable a workflow.

Referring again to FIG. 5, the requesting service 520 accesses the protected resource (file 515) to perform a function in a secure, flexible manner. For illustrative purposes only, and not to limit the inventive subject matter, FIG. 5 portrays a file upload and download use-case (the “File Upload/Download Use-case”) that executes on architecture 500. Initially, developer user 526 (which may comprise one or more users) designs, develops, and uses development tool 508 to deploy a set of services for file upload and download, which in turn may leverage other services on a platform. As will be readily understood by one of ordinary skill in the art, a variety of development tools may be employed to develop services.

In the File Upload/Download Use-case, user 526 builds two services, an Upload File Service 522 for file upload and a Download File Service 532 for file download. Services 522 and 532 rely on a Store File Service 524 for file storage in a database. The Store File Service 524 may be built by a different or the same user/group. User 526 also configures at least a portion of access control model 505 to allow services 522 and 532 to request file storage and retrieval to and from a database. The access control model 505 may be pre-configured to permit the services 522 and 532 to other services (such as Store File Service 524) and protected resources (such as file 515) to accomplish file upload and download. The access control model 505 may also include “blank” permission parameters that may be later instantiated to request and/or grant access as needed and/or desired (such as by another user 503 who sets up file upload and download tasks in workflows, as will be explained further below).

Once the Upload File Service 522 and the Download File Service 532 are deployed, including the access control model 505 and portions related thereto (such as policy definitions 507), user 501 requests (at 519) that file 515 be uploaded via Service A 520. The access control model 505 requires that Service A 520 be granted permission for file 515 upload which means that it must request authorization to Upload File Service 522 to perform the upload. Service A 520 requests such authorization from Authorization Service 510 (at 521A). Authorization Service 510 reviews policy definitions 507 in the access control model 505 to determine whether to grant Service A 520 access to Upload File Service 522. If granted, Service A 520 may then call Upload File Service 522 (at 521 B) to perform file 515 upload. Upload File Service 522 then requests Store File Service 524 to store file 515 in database 517. Here, Upload File Service 522 requests that Authorization Service 510 grant access (at 523) to Store File Service 524. If granted, Upload File Service 522 may then call Store File Service 524 to store file 515 in database 517. Store File Service 524 then requests Authorization Service 510 to grant access (at 525) to database 517, which may have already been granted in a previous file storage operation or set as the default when deployed. If granted, Store File Service 524 stores file 515 (at 527A) in database 517.

Alternatively, Authorization Service 510 may not grant access to requesting services, which prevents and/or blocks access to the services and protected resources. In these cases, a variety of methods for denying access may be employed, such as, but not limited to, sending an error message to requesting services, returning a null value to requesting services, etc. Further, the access control model may be modified to reflect any changes in permitted access, yet another enhancement enabled by the inventive subject matter.

The File Upload/Download Use-case further involves a user 502 request (at 529) via Service B 530 for file 515 download. Like Service A 520, Service B 530 must be granted permission to download the file 515 which means that it must request authorization to Download File Service 532 to perform the download. Service B 530 requests such authorization from Authorization Service 510 (at 531A). Authorization Service 510 reviews policy definitions 507 in the access control model 505 to determine whether to grant Service B 530 access to Download File Service 532. If granted, Service B 530 may then call Download File Service 532 (at 531 B) to perform file 515 download. Download File Service 532 must then request Store File Service 524 to retrieve file 515 in database 517. Here, as with Upload File Service 522, Download File Service 532 must be authorized to call Store File Service 524 and does so by asking Authorization Service 510 to grant access (at 533). If granted, Download File Service 532 may then call Store File Service 524 to retrieve file 515 from database 517. Store File Service 524 then requests Authorization Service 510 to grant access (at 525) to database 517. However, in one embodiment, because Store File Service 524 has already requested and been granted access to database 517 during the previous upload operation, Authorization Service 510 merely confirms the access grant and allows the retrieval operation to execute. If granted, Store File Service 524 retrieves file 515 (at 527B) from database 517 and sends it to Download File Service 532 and then file 515 is provided to user 502.

As can be noted from the File Upload/Download Use-case described above, Upload File

Service 522, Download File Service 532, and Store File Service 524, in addition to file 515, are treated as protected resources for which access permission must be configured and granted to perform pre-designated functions (such as file upload and download). In a further embodiment, subsequent requests by the requesting service to access the protected resource are based on the modified/fine-tuned policy definitions. Here, once services have been granted access, the policy definitions are modified so that subsequent requests for access may be granted without requiring that policy definitions be further modified. Advantageously, this may result in time, resource, and processing savings.

Another, non-limiting use-case involves a workflow (the “Workflow Use-case”) which calls Upload File Service 522 and Download File Service 532 as part of a workflow set of tasks for importing file 515 and exporting file 515. Here, the process to authorize and grant Service A 520, Service B 530 and Store File Service 524 access to protected resources may be like that described for the File Upload/Download Use-case. User 503, who may be a workflow manager and/or an administrator uses workflow tool 558 to setup workflows which leverage a variety of services, including protected resources, and involves users, groups, roles, permissions, and/or assigned and/or automated tasks to perform various functions. As will be readily understood by one of ordinary skill in the art, a variety of workflow tools may be employed to setup workflows.

User 503 may rely on pre-configured policy definitions for the workflow services and/or, if permitted, may instantiate or augment policy definitions as needed and/or desired to enable the workflows. In some instances, user 503 may upload policy definitions to setup and/or modify the access control model 505. In one embodiment of the Workflow Use-case, a workflow service 506 couples a set of services for accomplishing workflow tasks. In a non-limiting example, the workflow service 506 may call Service A 520 to initiate a file upload by user 501 (denoted by symbol “Y1” with a circle around it) and then, perhaps later in the workflow, may call Service B 530 to facilitate a file download by user 502 (denoted by symbol “Y2” with a circle around it).

In still a further embodiment, the policy definitions comprise a delegate control model 555 comprising delegate policy definitions 557. In this instance, the delegate control model 555 is used to determine and grant the requesting service access to the protected resource. The delegate control model 555 creates opportunities for other groups to define and fine-tune the access control model 505, such as to offload access and security to other parts of the enterprise or even different organizations and customers. This may be particularly useful for (but not limited to) workflows for which one user may setup the workflow, but other users in different groups determine policy definitions 507 in the access control model 505 for the workflow. The delegate control model 555 may reflect the format of the access control model 505, there may be a mapping from the access control model 505 to the delegate control model 555, or the delegate and access control models 555, 505 may be normalized into a common format.

In yet another embodiment, the access control model 505 comprises a namespace which comprises service role assignments, a service role delegate, user role assignments, a user role delegate, and a protected resource. The protected resource comprises service role assignments, a service role delegate, user role assignments, and a user role delegate.

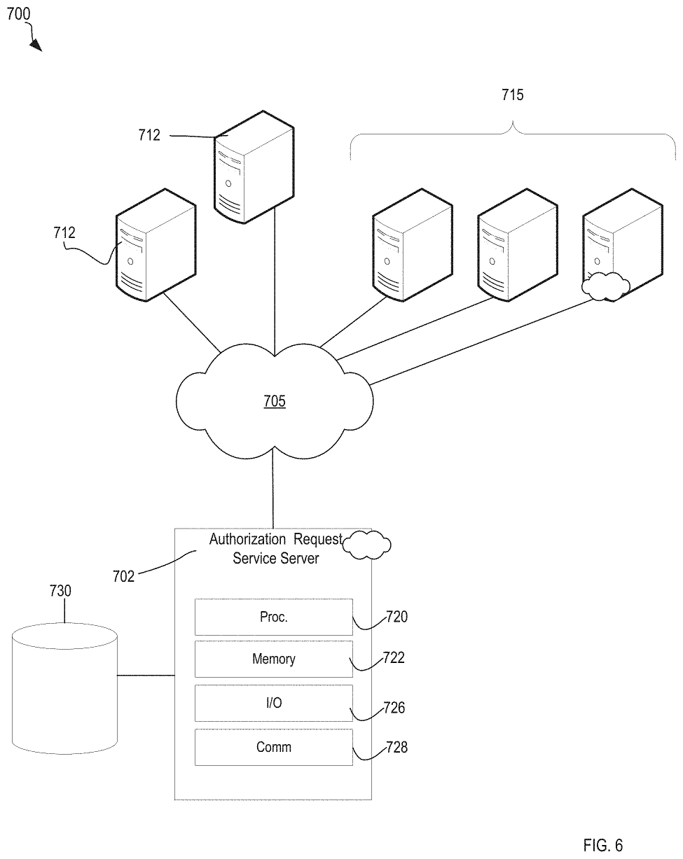

FIG. 6 is a diagrammatic representation of a distributed network computing environment where embodiments disclosed herein can be implemented. In the example illustrated, network computing environment 700 includes network 705 that can be bi-directionally coupled to an authorization service server computer 702, user computers 712, and server computers 715. Network 705 may represent a combination of wired and wireless networks that network computing environment 700 may utilize for various types of network communications known to those skilled in the art. For the purpose of illustration, a single system is shown for each of computers 702 and 712. However, each of computers 702 and 712 may comprise a plurality of computers (not shown) interconnected to each other over network 705. Server computers 715 may represent a variety of server computer systems including, but not limited to, cloud-based platforms that provide a variety of services. A server computer 715, authorization service server computer 702, or other computer in environment 700 can act as an authentication server that issues access tokens according to the OAuth 2.0 protocol or other protocol where the access tokens issued include, in some embodiments, and indication of the grant type according to which the access token was issued. In some embodiments, authorization service server computer 702 is a server computer that provides one or more services in the cloud platform. Further, in some embodiments, authorization service server computer 702 comprises a resource server (e.g., a ReST resource server).

Authorization service server computer includes a computer processor 720 and associated memory 722. Computer processor 720 may be an integrated circuit for processing instructions, such as but not limited to a central processing unit (CPU). Memory 722 may include volatile memory, non-volatile memory, semi-volatile memory, or a combination thereof. Memory 722, for example, may include RAM, ROM, flash memory, a hard disk drive, a solid-state drive, an optical storage medium (e.g., CD-ROM), or another computer-readable memory or combination thereof. Memory 722 may implement a storage hierarchy that includes cache memory, primary memory, or secondary memory. In some embodiments, memory 722 may include storage space on a data storage array. Authorization service server computer 702 may also include input/output (“I/O”) devices 726, such as a keyboard, monitor, printer, electronic pointing device (e.g., mouse, trackball, stylus, etc.), or the like, and a communication interface 728, such as a network interface card, to interface with network 705.

According to one embodiment, authorization service server computer 702 includes computer-executable instructions stored on a non-transitory computer-readable medium coupled to a processor. The computer-executable instructions of authorization service server computer 702 are executable to provide an authorization service, such as request authorization service 100, request authorization service 410 or authorization service 510. A portion of memory 722 may act as a data store for storing authorization policies, access control models and other data used by the authorization service server computer 702. In another embodiment, the datastore may be provided by, for example, a network filesystem or other network-connected storage. One or more services provided by the authorization service server computer 702 may use a database 730 (e.g., as provided by an RDBMS). Database 730 may be a portion of memory 722 or may be provided over a network by a database node.

Portions of the methods described herein may be implemented in suitable software code that may reside within RAM, ROM, a hard drive or another non-transitory storage medium. Alternatively, the instructions may be stored as software code elements on a data storage array, magnetic tape, floppy diskette, optical storage device, or other appropriate data processing system readable medium or storage device.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes, and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include but are not limited to, volatile and non-volatile computer memories and storage devices such as random-access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer-readable medium, hardware circuitry or the like, or any combination thereof.

Any suitable programming language can be used to implement the routines, methods, or programs of embodiments of the invention described herein, including C, C++, Java, JavaScript, HTML, or any other programming or scripting code, etc. Different programming techniques can be employed such as procedural or object-oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer-readable medium storing computer instructions executable by one or more processors in a computing environment. The computer-readable medium can be, by way of example only but not by limitation, an electronic, magnetic, optical, or another machine-readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when the antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature, or function, including any such embodiment feature or function, described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes, and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed:

1. A request authorization server comprising:
a memory configured with references to protected resources hosted by a resource server, authorization policies related to the protected resources, and assignments of users and services to the authorization policies, the authorization policies comprising client authorization policies for authorizing access by services executing in a cloud-based platform and user authorization policies for authorizing access by users of the cloud-based platform;
a processor coupled to the memory;
a non-transitory, computer-readable medium storing thereon a set of computer-executable instructions executable by the processor, the set of computer-executable instructions comprising instructions for:
receiving a request from an application for authorization to access a first protected resource hosted by the resource server;
based on a determination that the request is to access the first protected resource on behalf of a service, determining whether to authorize the request according to the client authorization policies;
based on a determination that the request is to access the first protected resource on behalf of a user, determining whether to authorize the request according to the user authorization policies.

2. The request authorization server of claim 1, wherein the set of computer-executable instructions further comprise instructions for providing different authorization policy control realms for the client authorization policies and the user authorization policies.

3. The request authorization server of claim 1, wherein the protected resources are organized according to namespaces, wherein the authorization policies comprise policies of a namespace scope and policies of a protected resource scope.

4. The request authorization server of claim 1, wherein the first protected resource to which access is requested is in a first namespace and wherein determining whether to authorize the request according to the client authorization policies comprises determining if the request is authorized based on any client authorization policies having a namespace scope of the first namespace.

5. The request authorization server of claim 4, wherein determining whether to authorize the request according to the client authorization policies comprises determining if the request is authorized based on any client authorization policies having a resource scope of the protected resource.

6. The request authorization server of claim 1, wherein the first protected resource to which access is requested is in a first namespace and wherein determining whether to authorize the request according to the user authorization policies comprises determining if the request is authorized based on any user authorization policies having a namespace scope of the first namespace.

7. The request authorization server of claim 6, wherein determining whether to authorize the request according to the user authorization policies comprises determining if the request is authorized based on any user authorization policies having a resource scope of the first protected resource.

8. The request authorization server of claim 1, wherein the set of computer-executable instructions further comprise instructions for: determining that the request is to access the first protected resource on behalf of a service when the request includes an access token granted according to a client credential grant.

9. The request authorization server of claim 8, wherein the set of computer-executable instructions further comprise instructions for: determining that the request is to access the first protected resource on behalf of a service when the request includes an access token granted according to an authorization code grant.

10. An access authorization method to authorize access to electronic resources in a computing environment, the method comprising:
configuring a memory with references to protected resources hosted by a resource server, authorization policies related to the protected resources, and assignments of users and services to the authorization policies, the authorization policies comprising client authorization policies for authorizing access by services executing in a cloud-based platform and user authorization policies for authorizing access by users of the cloud-based platform;
receiving a request from an application for authorization to access a first protected resource hosted by the resource server; and
based on a determination that the request is to access the first protected resource on behalf of a service, determining whether to authorize the request according to the client authorization policies.

11. The method of claim 10, further comprising providing different authorization policy control realms for the client authorization policies and the user authorization policies.

12. The method of claim 10, wherein the protected resources are organized according to namespaces, wherein the authorization policies comprise policies of a namespace scope and policies of a protected resource scope.

13. The method of claim 12, wherein the first protected resource to which access is requested is in a first namespace and wherein determining whether to authorize the request according to the client authorization policies comprises determining if the request is authorized based on any client authorization policies having a namespace scope of the first namespace.

14. The method of claim 13, wherein determining whether to authorize the request according to the client authorization policies comprises determining if the request is authorized based on any client authorization policies having a resource scope of the first protected resource.

15. The method of claim 10, further comprising determining that the request is to access the first protected resource on behalf of a service when the request includes an access token granted according to a client credential grant.

16. An access authorization method to authorize access to electronic resources in a computing environment, the method comprising:
configuring a memory with references to protected resources hosted by a resource server, authorization policies related to the protected resources, and assignments of users and services to the authorization policies, the authorization policies comprising client authorization policies for authorizing access by services executing in a cloud-based platform and user authorization policies for authorizing access by users of the cloud-based platform;
receiving a request from an application for authorization to access a first protected resource hosted by the resource server; and
based on a determination that the request is to access the first protected resource on behalf of a user, determining whether to authorize the request according to the user authorization policies.

17. The method of claim 16, wherein the protected resources are organized according to namespaces, wherein the authorization policies comprise policies of a namespace scope and policies of a protected resource scope.

18. The method of claim 17, wherein the protected resource to which access is requested is in a first namespace and wherein determining whether to authorize the request according to the user authorization policies comprises determining if the request is authorized based on any user authorization policies having a namespace scope of the first namespace.

19. The method of claim 18, wherein determining whether to authorize the request according to the user authorization policies comprises determining if the request is authorized based on any user authorization policies having a resource scope of the first protected resource.

20. The method of claim 16, further comprising determining that the request is to access the first protected resource on behalf of a service when the request includes an access token granted according to an authorization code grant.
